(19) United States
(12) Patent Application Publication
(10) Pub. No.: US 2026/0296016 A1
(43) Pub. Date: Oct. 1, 2026

(54) HEAD UNIT AND LIQUID DISCHARGE APPARATUS

(71) Applicants: Natsuki NISHI, Kanagawa (JP); Takahiro YOSHIDA, Kanagawa (JP)

(72) Inventors: Natsuki NISHI, Kanagawa (JP); Takahiro YOSHIDA, Kanagawa (JP)

(21) Appl. No.: 19/558,558

(22) Filed: Mar. 6, 2026

(30) Foreign Application Priority Data
Mar. 25, 2025 (JP) 2025-049449

(51) Int. Cl. B41J 2/15; B41J 2/21; B41J 25/00

(52) U.S. Cl. CPC B41J 2/15; B41J 2/2103; B41J 25/005

(57) ABSTRACT

A head unit includes: a first head and a second head. The first head has a first nozzle array and a second nozzle array disposed downstream of the first nozzle array in a second direction intersecting a first direction. The second head is disposed downstream of the first head in the second direction and arranged adjacent to the first head in a staggered manner. The second head has a third nozzle array and a fourth nozzle array disposed downstream of the third nozzle array in the second direction. Each of the first head and the second head has an overlapping region. The first nozzle array of the first head has a first nozzle density in the first direction in the overlapping region. The fourth nozzle array of the second head has a second nozzle density larger than the first nozzle density in the first direction in the overlapping region.

### CROSS-REFERENCE TO RELATED APPLICATION

This patent application is based on and claims priority pursuant to 35 U.S.C. § 119(a) to Japanese Patent Application No. 2025-049449, filed on Mar. 25, 2025, in the Japan Patent Office, the entire disclosure of which is hereby incorporated by reference herein.

### BACKGROUND

### Technical Field

The present disclosure relates to a head unit and a liquid discharge apparatus.

### Related Art

In a liquid discharge head, liquid is discharged from nozzles, and the liquid (liquid droplets) lands on a medium to form dots.

### SUMMARY

The present disclosure described herein provides an improved head unit including a first head and a second head. The first head has a first nozzle array and a second nozzle array. The first nozzle array has first multiple nozzles arrayed in a first direction. The second nozzle array is disposed downstream of the first nozzle array in a second direction intersecting the first direction and has second multiple nozzles arrayed in the first direction. The second head is disposed downstream of the first head in the second direction and arranged adjacent to the first head in a staggered manner. The second head has a third nozzle array and a fourth nozzle array. The third nozzle array has third multiple nozzles arrayed in the first direction. The fourth nozzle array is disposed downstream of the third nozzle array in the second direction and has fourth multiple nozzles arrayed in the first direction. Each of the first head and the second head has an overlapping region in which the first head and the second head overlap with each other in the first direction. The first nozzle array of the first head has a first nozzle density in the first direction in the overlapping region, and the fourth nozzle array of the second head has a second nozzle density larger than the first nozzle density in the first direction in the overlapping region.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIGS. 1A to 1C are schematic diagrams each illustrating a liquid discharge head discharging a liquid;

FIG. 2 is a schematic plan view of nozzles arrayed in liquid discharge heads according to a comparative example;

FIGS. 3A and 3B are a schematic plan view of nozzles arrayed in a first example of liquid discharge heads and a printing result thereof, respectively;

FIGS. 4A and 4B are a schematic plan view of nozzles arrayed in a second example of liquid discharge heads and a printing result thereof, respectively;

FIGS. 5A and 5B are a schematic plan view of nozzles arrayed in a third example of liquid discharge heads and a printing result thereof, respectively;

FIGS. 6A and 6B are a schematic plan view of nozzles arrayed in a fourth example of liquid discharge heads and a printing result thereof, respectively;

FIGS. 7A and 7B are a schematic plan view of nozzles arrayed in a fifth example of liquid discharge heads and a printing result thereof, respectively;

FIG. 8 is a plan view of a part of a liquid discharge apparatus;

FIG. 9 is a schematic side view of the liquid discharge apparatus of FIG. 8;

FIG. 10 is a plan view of a part of a liquid discharge unit;

FIG. 11 is a front view of another liquid discharge unit;

FIG. 12 is an exploded perspective view of a head module;

FIG. 13 is a further exploded perspective view of the head module FIG. 12;

FIG. 14 is an exploded perspective view of the head module of FIG. 13 as viewed from a nozzle face side;

FIG. 15 is a cross-sectional view of one head of the head module of FIG. 13 in a transverse direction of the head;

FIG. 16 is a schematic view of another liquid discharge apparatus;

FIG. 17 is a plan view of a head unit of the liquid discharge apparatus of FIG. 16;

FIG. 18 is another plan view of a head unit of the liquid discharge apparatus of FIG. 16; and

FIG. 19 is a schematic view of an electrode manufacturing apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

In a liquid discharge head, liquid is discharged from nozzles, and the liquid (liquid droplets) lands on a medium to form dots. The liquid discharged from the nozzles may land at a landing position deviating from a target position due to the influence of an airflow. In a comparative example, the landing position of the liquid is prevented from deviating from the target position.

Currently, a liquid discharge apparatus includes two or more liquid discharge heads arranged in a staggered manner in a longitudinal direction of the liquid discharge heads with an overlapping region therebetween.

In a comparative example, an ink discharge amount on a downstream side in a conveyance direction of the medium is controlled based on a conveyance airflow of the medium and an ink discharge density (self-airflow degree) on an upstream side in the conveyance direction of the medium. Accordingly, the deviation of the landing position of the liquid on the downstream side of the medium in the conveyance direction can be reduced, allowing the liquid discharge apparatus to form a desired image.

However, in the comparative example, since the liquid discharge apparatus mounts a system that determines the ink discharge amount on the downstream side in the conveyance direction of the medium based on the discharge amount on the upstream side in the conveyance direction of the medium, a control mechanism of the liquid discharge head or the liquid discharge apparatus may become complicated.

A head unit and a liquid discharge apparatus according to embodiments of the present disclosure are described in detail below with reference to the accompanying drawings. Embodiments of the present disclosure are not limited to the embodiments described below and may be other embodiments than the embodiments described below. The following embodiments may be modified by, for example, addition, modification, or omission within the scope that would be obvious to one skilled in the art. Any aspects having advantages as described for the following embodiments according to the present disclosure are included within the scope of the present disclosure.

The liquid discharge heads are provided with an overlapping region. At least two or more liquid discharge heads are arranged in a staggered manner in a longitudinal direction. Each liquid discharge head includes multiple nozzle arrays having nozzles to discharge a liquid onto a medium. The density of the nozzles arrayed in a nozzle array on an upstream side in the conveyance direction of the medium is lower in the overlapping region than the density of the nozzles arrayed in a nozzle array on the most downstream side in the conveyance direction of the medium.

An airflow due to the conveyance of the medium and an airflow due to the discharged liquid are generated near the liquid discharge head. The medium is a discharge target of liquid, which may be referred to as a printing medium, a medium for printing, a recording medium, or an object onto which liquid is discharged. The airflow caused by the conveyance of the medium may be referred to as a conveyance airflow, and the airflow caused by the discharged liquid may be referred to as a discharge airflow. An airflow vortex may be generated due to interference between the conveyance airflow and the discharge airflow, and the landing position of the discharged liquid (e.g., ink) may be deviated due to the airflow vortex.

The airflow vortex generated on the upstream side in the conveyance direction of the medium may affect not only the landing position of the liquid discharged from the nozzles on the upstream side but also the landing position of the liquid discharged from the nozzles on the downstream side. In the liquid discharge head, the nozzle density of the nozzle array on the upstream side in the conveyance direction of the medium is set to be lower than the nozzle density of the nozzle array on the most downstream side in the conveyance direction of the medium in the overlapping region. Thus, when two or more liquid discharge heads are arranged in a staggered manner in the longitudinal direction with the overlapping region, the discharge airflow on the upstream side is weakened, and the interference between the conveyance airflow and the discharge airflow on the upstream side is prevented. As a result, the influence of the airflow vortex can be reduced, and the landing position of the liquid discharged from the nozzles on the upstream side and the downstream side can be prevented from deviating.

In addition, the deviation of the landing position of the liquid can be prevented without a control mechanism in a system that changes the amount of liquid (ink) discharged on the downstream side according to the amount of liquid (ink) discharged on the upstream side, and thus the control mechanism can be prevented from being complicated. As a result, the deviation of the landing position of the liquid can be prevented without a complicated control mechanism to form a desired image.

In the present specification, the upstream side in the conveyance direction of the medium may be referred to simply as an upstream side. The downstream side in the conveyance direction of the medium may be referred to simply as a downstream side. The density of the nozzles (i.e., a nozzle density) means the density of the nozzles arrayed in a nozzle array direction (may be referred to simply as an array direction) unless otherwise specified.

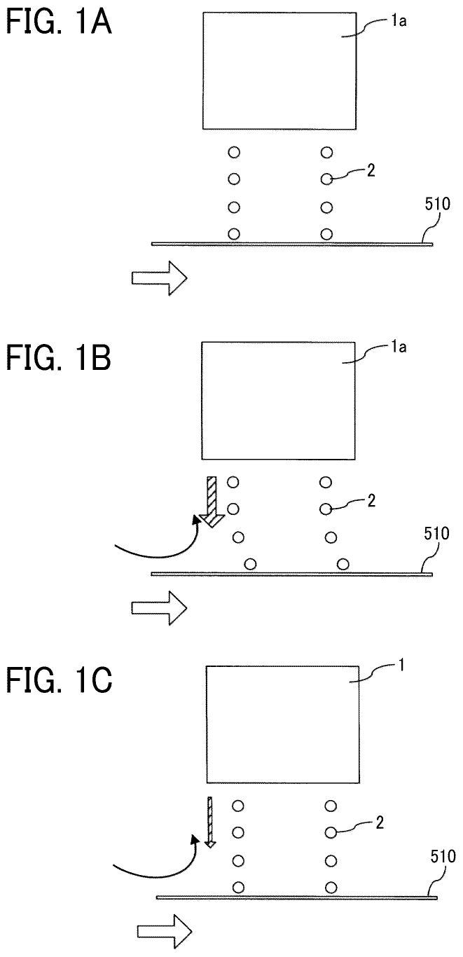

FIGS. 1A to 1C are schematic diagrams each illustrating a liquid discharge head discharging a liquid 2. In FIGS. 1A to 1C, outlined arrows indicate the conveyance direction of a medium 510.

FIG. 1A illustrates ideal landing positions of the liquid 2 on the medium 510. If no airflow is generated by the conveyance of the medium 510, the liquid 2 discharged from a liquid discharge head 1a flies and lands vertically on the medium 510. However, in reality, the conveyance airflow is generated by the conveyance of the medium 510, and the discharge airflow is generated by the liquid 2 that is discharged from the liquid discharge head 1a and flies in a space. When the conveyance airflow and the discharge airflow interfere with each other, the airflow vortex is generated. Accordingly, the liquid 2 discharged from the liquid discharge head 1a lands at positions deviated from the ideal landing positions illustrated in FIG. 1A.

FIG. 1B is a schematic diagram illustrating the liquid 2 that is discharged from the liquid discharge head 1a and lands at the positions deviated from the ideal landing positions due to the airflow vortex. In FIGS. 1B and 1C, hatched arrows indicate the discharge airflow, and black arrows indicate the conveyance airflow. FIG. 1B schematically illustrates the interference between the discharge airflow and the conveyance airflow. In FIG. 1B, the black arrow indicating the conveyance airflow is curved, but the hatched arrow indicating the discharge airflow may be curved.

FIG. 1C is a schematic diagram illustrating the liquid 2 that is discharged from a liquid discharge head 1 and lands on the medium 510 in the present embodiment. As illustrated in FIG. 1C, the liquid discharge head 1 can prevent the deviation of the landing position of the liquid 2 on the medium 510 to form a desired image.

When two or more liquid discharge heads are arranged in a staggered manner in the longitudinal direction with the overlapping region, the liquid discharge head 1 has the nozzle density of the nozzle array on the upstream side lower than the nozzle density of the nozzle array on the downstream side to reduce the discharge airflow on the upstream side. When the two or more liquid discharge heads are arranged in a staggered manner in the longitudinal direction with the overlapping region, such an arrangement of the nozzle arrays reduces the influence of the airflow vortex generated by the interference between the discharge airflow and the conveyance airflow to reduce the deviation of the landing position of the liquid 2 on the medium 510. The liquid discharge head 1 can reduce the deviation of the landing position with the nozzle arrays having predetermined nozzle densities. Accordingly, the control mechanism of the liquid discharge head or the apparatus does not become complicated.

### Comparative Example

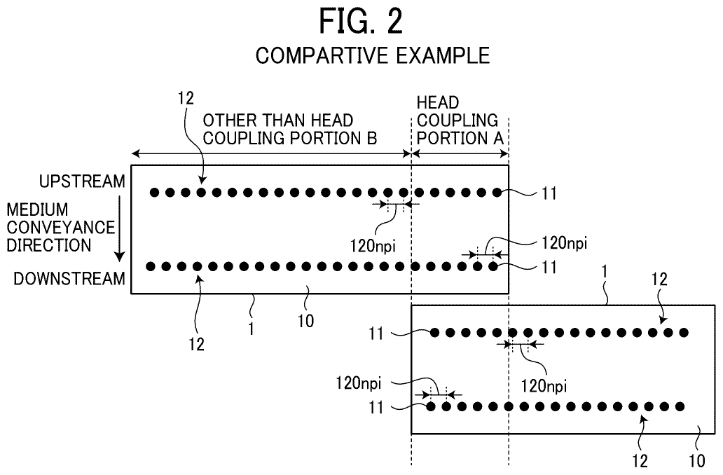

FIG. 2 is a schematic plan view of nozzles arrayed in liquid discharge heads according to a comparative example.

FIG. 2 illustrates the arrangement of nozzles 11. A head unit includes multiple liquid discharge heads 1 provided with the overlapping region (head coupling portion) A. At least two or more liquid discharge heads 1 are arranged in a staggered manner. The black arrow in FIG. 2 (the arrow pointing from the top to the bottom of the paper on which FIG. 2 is drawn) indicates the conveyance direction of the medium. A nozzle array 12 on the upstream side in the conveyance direction of the medium may be referred to as an upstream nozzle array 12. A nozzle array 12 at the most downstream in the conveyance direction of the medium may be referred to as the most downstream nozzle array 12 or simply as a downstream nozzle array 12.

As illustrated in FIG. 2, the nozzle density of the nozzles 11 of the upstream nozzle array 12 (first row) in the conveyance direction of the medium is 120 nozzles per inch (npi), and the nozzle density of the nozzles 11 of the most downstream nozzle array 12 (second row) in the conveyance direction of the medium is 120 npi.

In a typical liquid discharge head, the nozzle density of the nozzles 11 of the upstream nozzle array 12 is the same as the nozzle density of the nozzles 11 of the downstream nozzle array 12. In the comparative example, the nozzle densities of the nozzles 11 are the same on the upstream side and the downstream side. When one color is used in the liquid discharge head, i.e., when the colors of liquid (ink) are the same in the upstream nozzle array and the downstream nozzle array, the density of dots in an image printed on the medium (i.e., a printing result) is 240 dots per inch (dpi). In addition, in the comparative example, the nozzle densities of the nozzles 11 are the same on the upstream side and the downstream side as described above. When two colors are used in the liquid discharge head, i.e., when the colors of liquid (ink) are different in the upstream nozzle array and the downstream nozzle array, the density of dots of each of the two colors in an image printed on the medium is 120 dpi.

The nozzle density (npi) can be calculated by selecting a straight line extending in the nozzle array direction and counting the nozzles per inch on the straight line. For example, when the nozzle densities are the same on the upstream side and the downstream side, a numerical value (%) expressed by {(nozzle density on upstream side−nozzle density on downstream side)/(nozzle density on upstream side)}×100 is less than ±1%.

In the comparative example, as illustrated in FIG. 1B, the landing position may deviate due to the airflow vortex generated by the interference between the discharge airflow caused by the upstream nozzle array 12 and the conveyance airflow, and thus a desired image may not be obtained.

### First Example

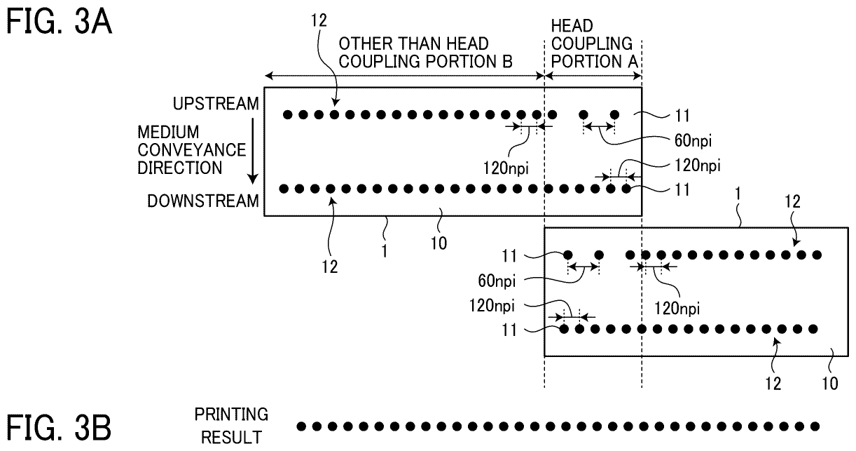

FIGS. 3A and 3B are a schematic plan view of the nozzles 11 arrayed in a first example of the liquid discharge heads 1 and a printing result thereof, respectively. FIG. 3A illustrates the nozzle arrangement of the nozzles 11, and FIG. 3B illustrates an example of the printing result. As illustrated in FIG. 3A, the shape of a nozzle plate 10, on which the nozzle arrays 12 of the liquid discharge head 1 are formed, is rectangular. A head unit includes the liquid discharge heads 1 (i.e., a first head and a second head) provided with the overlapping region (head coupling portion) A. At least two or more liquid discharge heads 1 are arranged in a staggered manner in the longitudinal direction of the liquid discharge head 1 (i.e., a first direction).

As illustrated in FIG. 3A, the liquid discharge head 1 has a nozzle configuration in which the nozzle density of the nozzles 11 of the upstream nozzle array 12 is lower than the nozzle density of the nozzle 11 of the downstream nozzle array 12 in the overlapping region (head coupling portion) A. In addition, as illustrated in FIGS. 3A and 3B, liquid is discharged in the overlapping region (head coupling portion) A from the nozzles 11 of the upstream nozzle array 12 having a low nozzle density of both the two liquid discharge heads 1 overlapped with each other to form an image having dots arranged at a dot density on a medium. Accordingly, the dot density in the overlapping region A of the image of the printing result is equal to the dot density in a region B (i.e., a non-overlapping region) other than the overlapping region (head coupling portion) A.

In the liquid discharge head 1 illustrated in FIG. 3A, each of the two nozzle arrays 12 basically has a nozzle density of 120 npi of the nozzles 11. The nozzle density of the nozzles 11 in the region B other than the overlapping region (head coupling portion) A is equal to 120 npi in the upstream nozzle array 12 and the downstream nozzle array 12.

In the overlapping region (head coupling portion) A, the nozzle density of the nozzles 11 of the downstream nozzle array 12 is 120 npi, but the nozzle density of the nozzles 11 of the upstream nozzle array 12 is 60 npi, which is ½ of the nozzle density of the nozzles 11 of the downstream nozzle array 12.

In the overlapping region (head coupling portion) A, liquid is discharged from the nozzles 11 of the upstream nozzle arrays 12 of both the liquid discharge heads 1 overlapped with each other, so that the printing result has the dot density of 120 dpi.

Accordingly, as illustrated in the printing result of FIG. 3B, in the end portion, i.e., the overlapping region (head coupling portion) A, of the liquid discharge heads 1 arranged in a staggered manner, the nozzle density of the nozzles 11 on the upstream side in the conveyance direction of the medium is lower than that on the downstream side. As a result, the discharge airflow of the upstream nozzle array 12 received by the liquid droplets can be prevented regardless of the printing condition (e.g., a conveyance speed of the medium), and thus the airflow vortex due to the interference between the conveyance airflow of the medium and the discharge airflow on the upstream side can be prevented. In addition, both the liquid discharge heads 1 overlapped with each other in the overlapping region (head coupling portion) A discharge liquid from the nozzles 11 in the overlapping region A. Thus, the dot density in the overlapping region A is equal to the dot density in the region B other than the overlapping region A when the liquid discharge heads 1 are arranged in a staggered manner and joined to each other. As a result, the dot density of the printing result can be prevented from being reduced, and the image quality can be maintained.

The number of the nozzles 11 overlapped with each other in the downstream nozzle array 12 is large. If a streak appears in an image in the overlapping region (head coupling portion) A, for example, due to an assembly error of the head, the nozzles 11 in the downstream nozzle array 12 may be used to discharge liquid to complement the streak.

The number of the nozzle arrays 12 may be more than two. When the liquid discharge head 1 has three or more nozzle arrays 12, the nozzle density of the nozzle 11 in the most upstream row of the nozzle arrays 12 may be set to ½ of the nozzle density of the nozzle 11 in the downstream nozzle array 12.

How much lower to make the nozzle density of the nozzles 11 of the upstream nozzle array 12 than the nozzle density of the nozzles 11 of the downstream nozzle array 12 can be appropriately selected. In the first example, the nozzle density of the nozzles 11 of the upstream nozzle array 12 is ½ of the nozzle density of the nozzles 11 of the downstream nozzle array 12. The nozzle density of the nozzles 11 of the upstream nozzle array 12 is not limited thereto, and may be lower than ½ of the nozzle density of the nozzles 11 of the downstream nozzle array 12. The nozzle density of the nozzles 11 of the upstream nozzle array 12 is preferably, but is not limited to, within a range of 1/10 to ½ of the nozzle density of the nozzles 11 of the most downstream nozzle array 12. Such a range of the nozzle density can weaken the discharge airflow caused by the nozzles 11 in the upstream nozzle array 12 and does not affect the printing result.

### Second Example

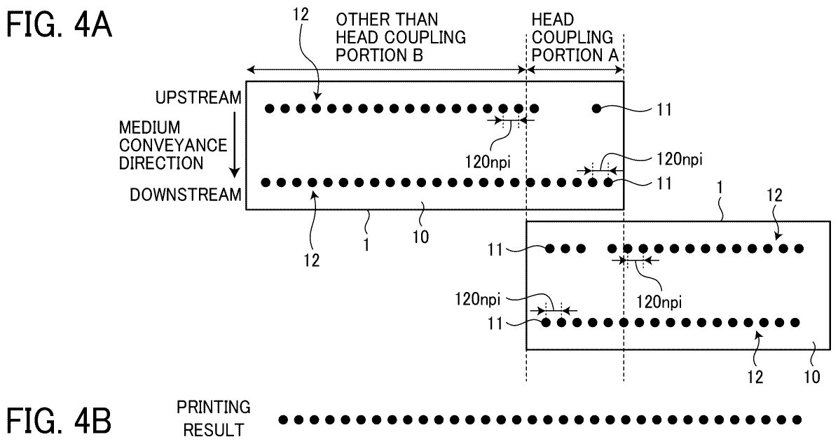

FIGS. 4A and 4B are a schematic plan view of nozzles arrayed in a second example of liquid discharge heads and a printing result thereof, respectively. FIG. 4A illustrates the nozzle arrangement of the nozzles 11, and FIG. 4B illustrates an example of the printing result.

In the first example, the nozzle density of the nozzles 11 in the most upstream nozzle array 12 is set to ½ of that in the downstream nozzle array 12. However, as illustrated in FIG. 4A, as long as the nozzle density of the nozzles 11 in the most upstream nozzle array 12 is lower than that in the downstream nozzle array 12, the nozzle density of the nozzles 11 in the most upstream nozzle array 12 is not necessarily set to ½ of that in the downstream nozzle array 12. However, the dot density of the printing result in the overlapping region (head coupling portion) A is set to be equal to the dot density in the region B other than the overlapping region (head coupling portion) A.

At this time, among at least two or more liquid discharge heads 1 arranged in a staggered manner, the nozzle density of the nozzles 11 in the upstream nozzle array 12 of the liquid discharge head 1 disposed upstream in the conveyance direction is set to be lower than the nozzle density of the nozzles 11 in the upstream nozzle array 12 of the liquid discharge head 1 disposed downstream in the conveyance direction.

With such a configuration, the interference between the discharge airflow and the conveyance airflow can be effectively reduced. This is because the discharge airflow is more likely to escape upstream and interfere with the conveyance airflow on the upstream side in the conveyance direction because there is no nozzle array 12 in the upstream direction.

### Third Example

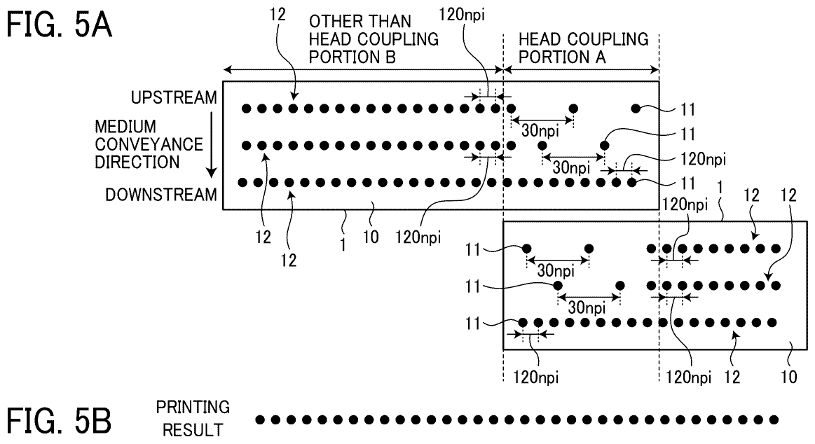

FIGS. 5A and 5B are a schematic plan view of nozzles arrayed in a third example of liquid discharge heads and a printing result thereof, respectively. FIG. 5A illustrates the nozzle arrangement of the nozzles 11, and FIG. 5B illustrates an example of the printing result.

In the first and second examples, the liquid discharge head 1 has the two nozzle arrays 12 and the nozzle density of 120 npi of the nozzles 11 as the basic configuration as described above. In the third example, the liquid discharge head 1 has three nozzle arrays 12 and the nozzle density 120 npi of the nozzles 11 as the basic configuration. In the third example, the nozzle arrays 12 in the first and second rows from the upstream side in the conveyance direction of the medium are the upstream nozzle arrays 12, and the nozzle array in the third row is the most downstream nozzle array 12 in the conveyance direction of the medium.

The nozzle density of the nozzles 11 of the nozzle arrays 12 in the region B other than the overlapping region (head coupling portion) A is equal to 120 npi in all the nozzle arrays 12.

In the overlapping region (head coupling portion) A, the nozzle density of the nozzles 11 of the most downstream nozzle array 12 is 120 npi, but the nozzle density of the nozzles 11 of the two upstream nozzle arrays 12 is 30 npi, which is ¼ of the nozzle density of the nozzles 11 of the most downstream nozzle array 12.

In the overlapping region (head coupling portion) A, liquid is discharged from the nozzles 11 of the upstream nozzle arrays 12 of both the liquid discharge heads 1 overlapped with each other, so that the printing result has the dot density of 120 dpi.

As a result, as compared with a configuration in which the nozzle density of the nozzle 11 is reduced in only one row of the most upstream nozzle array 12, the nozzle density can be further reduced in the upstream nozzle arrays 12 to reduce the discharge airflow. Accordingly, the interference between the discharge airflow and the conveyance airflow can be prevented.

The number of the nozzle arrays 12 may be three or more, and the number of the upstream nozzle arrays 12 in which the nozzle density of the nozzles 11 is reduced may be two or more. When the nozzle density of the nozzles 11 is reduced in N upstream nozzle arrays 12 (i.e., N rows of the upstream nozzle array 12), the nozzle density of the nozzles 11 in the N upstream nozzle arrays 12 is set to 1/(2N) of the nozzle density of the nozzles 11 in the downstream nozzle array 12.

### Fourth Example

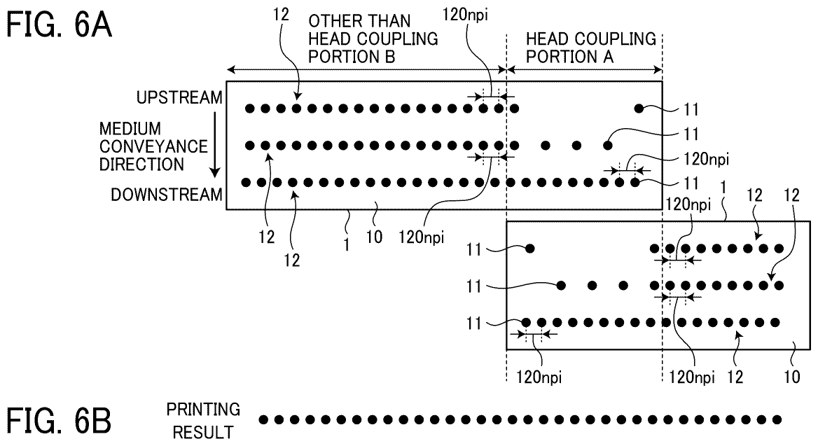

FIGS. 6A and 6B are a schematic plan view of nozzles arrayed in a fourth example of liquid discharge heads and a printing result thereof, respectively. FIG. 6A illustrates the nozzle arrangement of the nozzles 11, and FIG. 6B illustrates an example of the printing result.

In the third example, in the overlapping region (head coupling portion) A, the nozzle density of the nozzles 11 of the two upstream nozzle arrays 12 is ¼ of the nozzle density of the nozzles 11 of the most downstream nozzle array 12. However, as in the fourth example illustrated in FIG. 6, the nozzle density of the nozzles 11 of the two upstream nozzle arrays 12 is not limited to ¼ of the nozzle density of the nozzles 11 of the most downstream nozzle array 12.

However, the dot density of the printing result in the overlapping region (head coupling portion) A is set to be equal to the dot density in the region B other than the overlapping region (head coupling portion) A.

At this time, when the nozzle density of the nozzle 11 in the most upstream nozzle array 12 is made the smallest, the interference between the discharge airflow and the conveyance airflow can be effectively prevented. In other words, the two or more upstream nozzle arrays each have the nozzle density that decreases upstream in the conveyance direction (first direction). This is because the discharge airflow due to the most upstream nozzle array 12 is more likely to escape in the upstream direction and interfere with the conveyance airflow because there is no nozzle array 12 upstream from the most upstream nozzle array 12 in the conveyance direction.

### Fifth Example

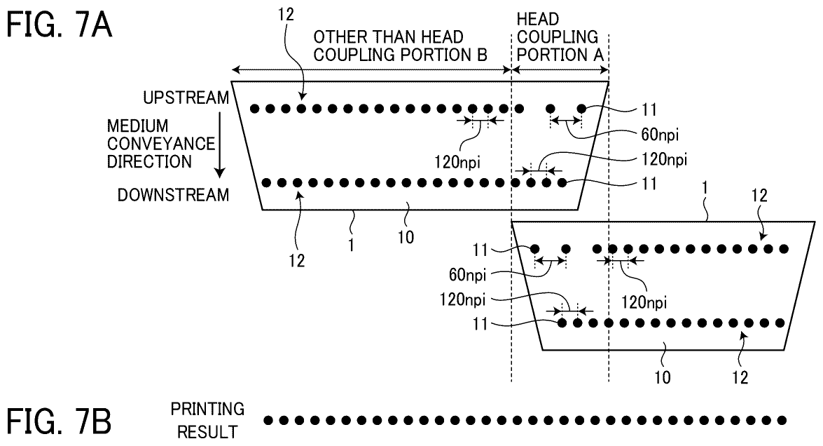

FIGS. 7A and 7B are a schematic plan view of nozzles arrayed in a fifth example of liquid discharge heads and a printing result thereof, respectively. FIG. 7A illustrates the nozzle arrangement of the nozzles 11, and FIG. 7B illustrates an example of the printing result.

In the first to fourth embodiments, the nozzle plate 10 on which the nozzle arrays 12 of the liquid discharge head 1 are formed has, but is not limited to, a rectangular shape. The nozzle plate 10 of the liquid discharge head 1 may have a trapezoidal shape.

The liquid discharge heads 1 are provided with the overlapping region (head coupling portion) A. At least two or more liquid discharge heads 1 are arranged in a staggered manner in the longitudinal direction of the liquid discharge head 1 with the longer base of the trapezoidal shape of the nozzle plate 10 facing upstream in the conveyance direction. The nozzle arrays 12 are formed on the nozzle plate 10.

Such a configuration can reduce the number of the nozzles 11 in the downstream nozzle array 12 not used in the overlapping region A to reduce the area of the nozzle plate 10 as a whole.

### Liquid Discharge Unit and Liquid Discharge Apparatus

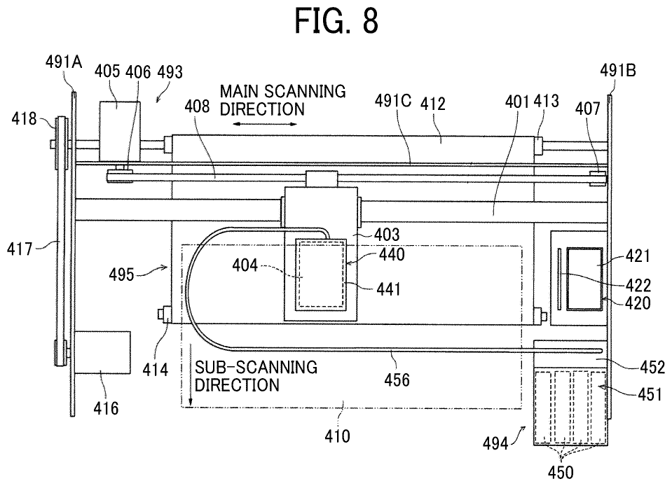

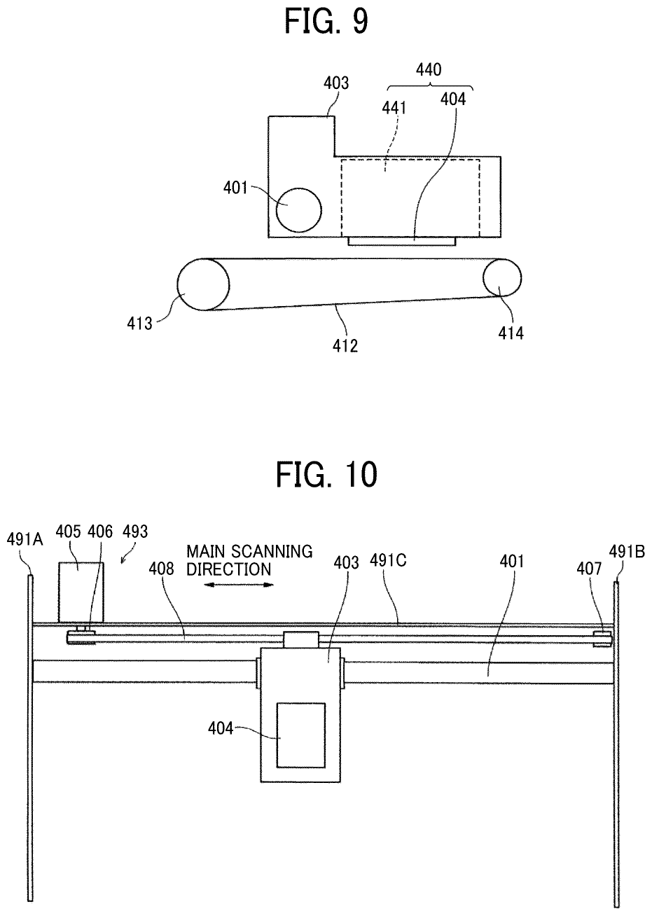

A liquid discharge apparatus is described below with reference to FIGS. 8 and 9. FIG. 8 is a plan view of a part of a liquid discharge apparatus. FIG. 9 is a schematic side view of the liquid discharge apparatus of FIG. 8.

The liquid discharge apparatus is a serial-type apparatus in which a main-scanning moving mechanism 493 reciprocates a carriage 403 in a main scanning direction. The main-scanning moving mechanism 493 includes, for example, a guide 401, a main scanning motor 405, and a timing belt 408. The guide 401 is bridged between left and right side plates 491A and 491B to movably hold the carriage 403. The main scanning motor 405 reciprocates the carriage 403 in the main scanning direction via the timing belt 408 looped around a drive pulley 406 and a driven pulley 407.

The carriage 403 includes a liquid discharge unit 440 in which liquid discharge heads 404 (e.g., the liquid discharge head 1 described above) and a head tank 441 are integrated into a single unit. The liquid discharge heads 404 of the liquid discharge unit 440 discharge color liquids of, for example, yellow (Y), cyan (C), magenta (M), and black (K). The liquid discharge heads 404 are mounted on the liquid discharge unit 440 of the carriage 403. The liquid discharge heads 404 have the multiple nozzle arrays 12 arrayed in the main scanning direction. Each of the multiple nozzle arrays 12 has the multiple nozzles 11 arrayed in the sub-scanning direction orthogonal to (or intersecting) the main scanning direction. The liquid discharge heads 404 discharge the color liquids downward.

A supply mechanism 494 disposed outside the liquid discharge heads 404 supplies liquid stored in liquid cartridges 450 to the head tank 441 to supply the liquid to the liquid discharge heads 404.

The supply mechanism 494 includes a cartridge holder 451 which is a loading device to mount the liquid cartridges 450, a tube 456, and a liquid feed unit 452 including a liquid feed pump. The liquid cartridge 450 is detachably mounted on the cartridge holder 451. The liquid feed unit 452 feeds the liquid from the liquid cartridge 450 to the head tank 441 via the tube 456.

The liquid discharge apparatus further includes a conveyance mechanism 495 to convey a sheet 410 (i.e., a medium). The conveyance mechanism 495 includes a conveyance belt 412 (i.e., a conveyor) and a sub-scanning motor 416 to drive the conveyance belt 412.

The conveyance belt 412 attracts the sheet 410 and conveys the sheet 410 to a position facing the liquid discharge head 404. The conveyance belt 412 is an endless belt looped around a conveyance roller 413 and a tension roller 414. The sheet 410 can be attracted to the conveyance belt 412 by, for example, electrostatic attraction or air suction.

The conveyance belt 412 circumferentially moves in the sub-scanning direction as the conveyance roller 413 is rotationally driven by the sub-scanning motor 416 via a timing belt 417 and a timing pulley 418.

On one end of the range of movement of the carriage 403 in the main scanning direction, a maintenance mechanism 420 that maintains and recovers the liquid discharge head 404 is disposed lateral to the conveyance belt 412. The maintenance mechanism 420 includes, for example, a cap 421 to cap the nozzle face (i.e., the surface on which the nozzles 11 are formed) of the liquid discharge head 404 and a wiper 422 to wipe the nozzle face.

The main-scanning moving mechanism 493, the supply mechanism 494, the maintenance mechanism 420, and the conveyance mechanism 495 are mounted onto a housing including the side plates 491A and 491B and a back plate 491C.

In the liquid discharge apparatus having the above-described configuration, the sheet 410 is fed and attracted onto the conveyance belt 412 and conveyed in the sub-scanning direction as the conveyance belt 412 circumferentially moves.

The liquid discharge head 404 is driven in response to an image signal while the carriage 403 moves in the main scanning direction to discharge liquid onto the sheet 410 not in motion. As a result, an image is formed on the sheet 410.

As described above, the liquid discharge apparatus includes the liquid discharge heads 404 (e.g., the liquid discharge heads 1), thus allowing the stable formation of high-quality images.

Another liquid discharge unit is described below with reference to FIG. 10. FIG. 10 is a plan view of a part of the liquid discharge unit. The liquid discharge unit includes the housing, the main-scanning moving mechanism 493, the carriage 403, and the liquid discharge heads 404 among the components of the liquid discharge apparatus described above. The side plates 491A and 491B, and the back plate 491C construct the housing. The liquid discharge unit may further include at least one of the maintenance mechanism 420 or the supply mechanism 494, which may be attached to the side plate 491B.

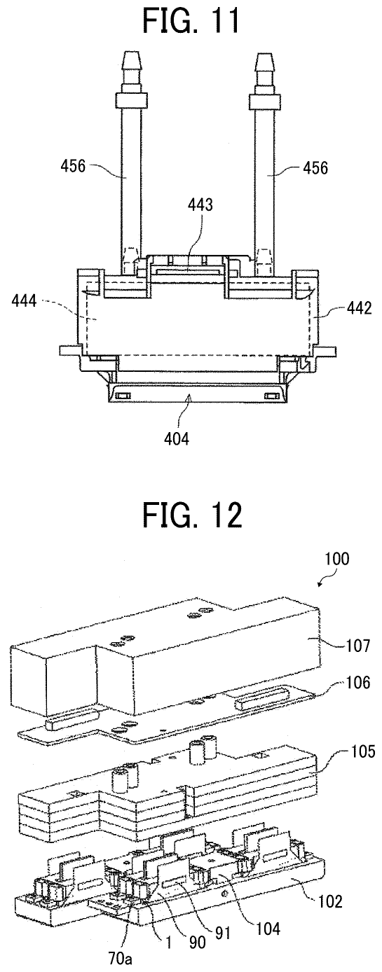

Still another liquid discharge unit is described below with reference to FIG. 11. FIG. 11 is a front view of another liquid discharge unit. The liquid discharge unit includes the liquid discharge heads 404 to which a channel component 444 is attached, and tubes 456 connected to the channel component 444. The channel component 444 is disposed inside a cover 442. Alternatively, the liquid discharge unit 440 may include the head tank 441 instead of the channel component 444. A connector 443 for electrically connecting to the liquid discharge heads 404 is disposed on an upper portion of the channel component 444.

In the above-described embodiments, the “liquid discharge apparatus” includes the liquid discharge head or the liquid discharge unit and drives the liquid discharge head to discharge liquid. The liquid discharge apparatus may be, for example, any apparatus that can discharge liquid to a medium onto which liquid can adhere or any apparatus to discharge liquid toward gas or into a different liquid.

The “liquid discharge apparatus” may further include devices relating to feeding, conveying, and ejecting of the medium onto which liquid can adhere and also include a pretreatment device and an aftertreatment device.

The “liquid discharge apparatus” may be, for example, an image forming apparatus to form an image on a sheet by discharging ink, or a three-dimensional fabrication apparatus to discharge fabrication liquid to a powder layer in which powder material is formed in layers, so as to form a three-dimensional object.

The “liquid discharge apparatus” is not limited to an apparatus that discharges liquid to visualize meaningful images such as letters or figures. For example, the discharge apparatus may be an apparatus that forms patterns having no meaning or an apparatus that fabricates three-dimensional images.

The above-described term “medium onto which liquid can adhere” represents a medium on which liquid is at least temporarily adhered, a medium on which liquid is adhered and fixed, or a medium into which liquid adheres and permeates. Specific examples of the “medium onto which liquid can adhere” include, but are not limited to, a recording medium such as a paper sheet, recording paper, a recording sheet of paper, a film, or cloth, an electronic component such as an electronic substrate or a piezoelectric element, and a medium such as layered powder, an organ model, or a testing cell. The “medium onto which liquid can adhere” includes any medium to which liquid adheres, unless otherwise specified.

Examples of materials of the “medium onto which liquid can adhere” include any materials to which liquid can adhere even temporarily, such as paper, thread, fiber, fabric, leather, metal, plastic, glass, wood, ceramic, construction materials (e.g., wallpaper or floor material), and cloth textile.

Examples of the “liquid” include ink, treatment liquid, deoxyribonucleic acid (DNA) sample, resist, pattern material, binder, fabrication liquid, and solution or liquid dispersion containing amino acid, protein, or calcium.

The liquid discharge apparatus may be an apparatus to move the liquid discharge head and the medium onto which liquid can adhere relative to each other. However, the liquid discharge apparatus is not limited to such an apparatus. For example, the liquid discharge apparatus may be a serial head apparatus that moves the liquid discharge head or a line head apparatus that does not move the liquid discharge head. In consideration of the interference of airflows, the line-type is preferable.

Examples of the liquid discharge apparatus further include: a treatment liquid applying apparatus that discharges a treatment liquid onto a sheet to apply the treatment liquid to the surface of the sheet, for reforming the surface of the sheet; and an injection granulation apparatus that injects a composition liquid, in which a raw material is dispersed in a solution, through a nozzle to granulate fine particle of the raw material.

The “liquid discharge unit” refers to a liquid discharge head integrated with functional components or mechanisms, i.e., an assembly of components related to liquid discharge. For example, the “liquid discharge unit” includes a combination of the liquid discharge head with at least one of a head tank, a carriage, a supply mechanism, a maintenance mechanism, or a main-scanning moving mechanism.

The above integration may be achieved by, for example, a combination in which the liquid discharge head and a functional component(s) or mechanism(s) are fixed to each other through, e.g., fastening, bonding, or engaging, and a combination in which one of the liquid discharge head and the functional component(s) or mechanism(s) is movably held to the other. The liquid discharge head and the functional component(s) or mechanism(s) may be detachably attached to each other.

Examples of the liquid discharge unit include the liquid discharge unit 440 in which a liquid discharge head and a head tank are integrated, as illustrated in FIG. 9. Alternatively, the liquid discharge head and the head tank coupled (connected) to each other via, for example, a tube may form the liquid discharge unit as a single unit. A unit including a filter may further be added to a portion between the head tank and the liquid discharge head of the liquid discharge unit.

In another example, the liquid discharge unit may be an integrated unit in which a liquid discharge head is integrated with a carriage.

As yet another example, the liquid discharge unit is a unit in which the liquid discharge head and the main-scanning moving mechanism are combined into a single unit. The liquid discharge head is movably held by a guide that is a part of the main-scanning moving mechanism. Like the liquid discharge unit illustrated in FIG. 10, the liquid discharge head, the carriage, and the main-scanning moving mechanism may form the liquid discharge unit as a single unit.

In another example, the cap that forms a part of the maintenance mechanism is fixed to the carriage mounting the liquid discharge head so that the liquid discharge head, the carriage, and the maintenance mechanism are integrated as a single unit to form the liquid discharge unit.

Further, in still another example, the liquid discharge unit includes tubes connected to the liquid discharge head to which the head tank or the channel component is attached so that the liquid discharge head and the supply mechanism are integrated as a single unit, as illustrated in FIG. 11.

The main-scanning moving mechanism may be a guide only. The supply mechanism may be a tube(s) only or a loading device only.

The pressure generator used in the liquid discharge head is not limited to a particular type of pressure generator. The pressure generator is not limited to the piezoelectric actuator (or a laminated-type piezoelectric element) described in the above-described embodiments, and may be, for example, a thermal actuator that employs a thermoelectric transducer, such as a thermal resistor, or an electrostatic actuator including a diaphragm and opposed electrodes.

In the present specification, the terms “image formation,” “recording,” “printing,” “image printing,” and “fabricating” used herein may be used synonymously with each other.

### Another Liquid Discharge Unit and Another Liquid Discharge Apparatus

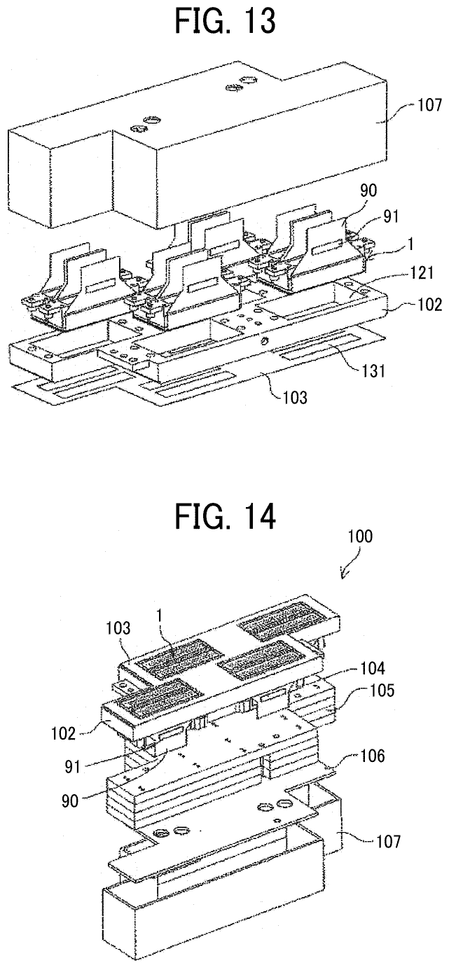

Another liquid discharge unit and another liquid discharge apparatus will be described below. The liquid discharge head or the liquid discharge unit may be a head module. FIG. 12 is an exploded perspective view of a head module. FIG. 13 is a further exploded perspective view of the head module of FIG. 12. FIG. 14 is an exploded perspective view of the head module of FIG. 13 as viewed from a nozzle face side.

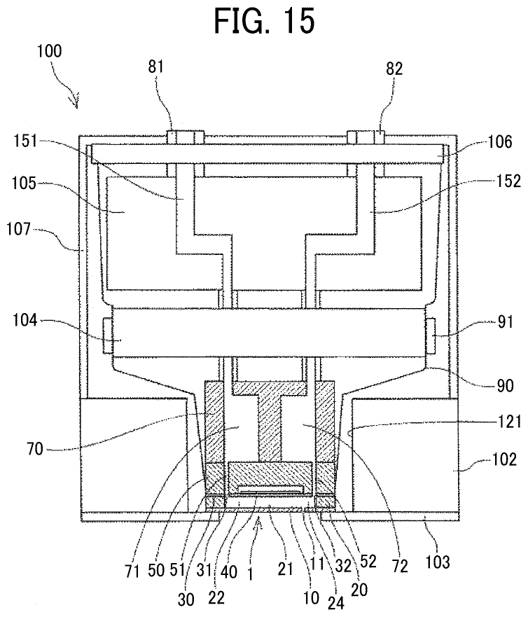

FIG. 15 is a cross-sectional view of one head of the head module of FIG. 13 in a transverse direction of the head. A head module 100 includes multiple heads 1 to discharge a liquid, a base 102, a cover 103, a heat radiator 104, a manifold 105, a printed circuit board (PCB) 106, and a module case 107.

The head 1 (i.e., the liquid discharge head 1) includes a nozzle plate 10, an individual channel plate 20, a diaphragm 30, an intermediate channel plate 50, and a common channel substrate 70. The nozzles 11 are formed in the nozzle plate 10. The individual channel plate 20 defines pressure chambers 21 communicating with the nozzles 11, respectively. The diaphragm 30 includes a piezoelectric element 40. The intermediate channel plate 50 is laminated on the diaphragm 30. The common channel substrate 70 is laminated on the intermediate channel plate 50.

In addition to the pressure chambers 21, the individual channel plate 20 defines individual supply channels 22 communicating with the pressure chambers 21 and individual collection channels 24 communicating with the pressure chambers 21, respectively.

The intermediate channel plate 50 defines intermediate supply channels 51 and intermediate collection channels 52. The intermediate supply channels 51 communicate with the individual supply channels 22 via openings 31 of the diaphragm 30, respectively. The intermediate collection channels 52 communicate with the individual collection channels 24 via openings 32 of the diaphragm 30, respectively.

The common channel substrate 70 defines a common supply channel 71 communicating with the intermediate supply channels 51 and a common collection channel 72 communicating with the intermediate collection channels 52. The common supply channel 71 communicates with a supply port 81 via a channel 151 of the manifold 105. The common collection channel 72 communicates with a collection port 82 via a channel 152 of the manifold 105.

The PCB 106 and the piezoelectric element 40 of the head 1 are connected to each other via a flexible wiring 90, and a driver integrated circuit (IC) 91 is mounted on the flexible wiring 90.

Each of the multiple heads 1 is inserted into an opening 121 of the base 102, and the peripheral edge of the nozzle plate 10 of the head 1 is bonded to the cover 103 bonded and fixed to the base 102 with an adhesive to fix the head 1. The cover 103 has an opening 131 corresponding to the region of the nozzles 11 of the nozzle plate 10, and the cover 103 covers the peripheral edge of the nozzle plate 10 of the head 1. A flange 70a disposed outside the common channel substrate 70 in the longitudinal direction of the head 1 is bonded and fixed to the base 102.

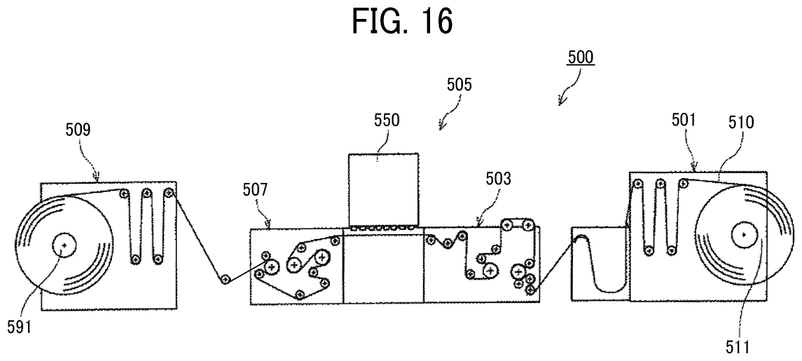

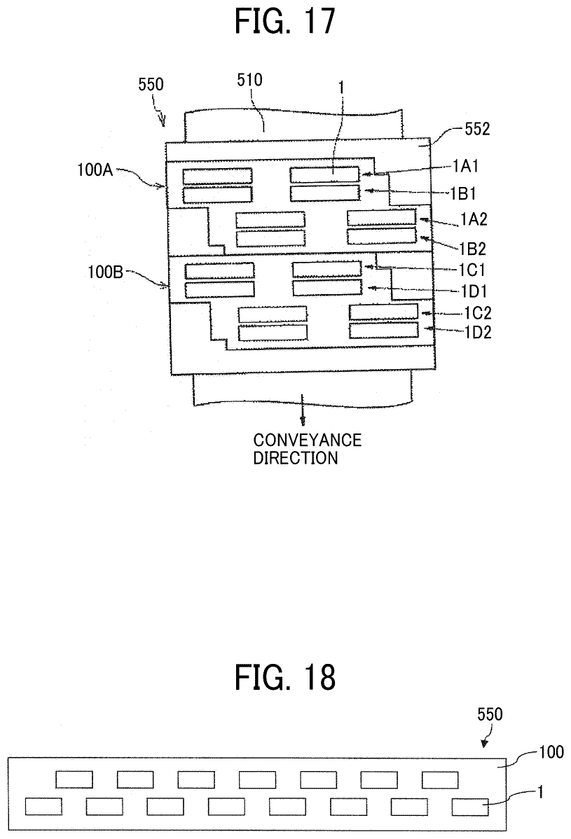

Another liquid discharge apparatus will be described below with reference to FIGS. 16 and 17. FIG. 16 is a schematic view of another liquid discharge apparatus. FIG. 17 is a plan view of a head unit of the liquid discharge apparatus of FIG. 16.

A printer 500 as a liquid discharge apparatus includes a feeder 501, a guide conveyor 503, a printing device 505, a dryer 507, and a carrier 509. The feeder 501 feeds a continuous medium 510 inward. The guide conveyor 503 (i.e. a conveyor) guides and conveys the continuous medium 510 such as a continuous sheet of paper or a sheet medium fed inward from the feeder 501. The printing device 505 performs printing by discharging liquid onto the continuous medium 510 to form an image. The dryer 507 dries the continuous medium 510 with the image formed. The carrier 509 feeds the dried continuous medium 510 outward.

The continuous medium 510 (i.e., a medium) is fed from a winding roller 511 of the feeder 501, guided and conveyed with rollers of the feeder 501, the guide conveyor 503, the dryer 507, and the carrier 509, and wound around a take-up roller 591 of the carrier 509.

In the printing device 505, the continuous medium 510 is conveyed so as to face a head unit 550. The head unit 550 discharges a liquid onto the continuous medium 510 to form an image.

As illustrated in FIG. 17, the head unit 550 includes two head modules 100A and 100B on a common base 552. The head module 100A includes head arrays 1A1, 1B1, 1A2, and 1B2, and the head module 100B includes head arrays 1C1, 1D1, 1C2, and 1D2.

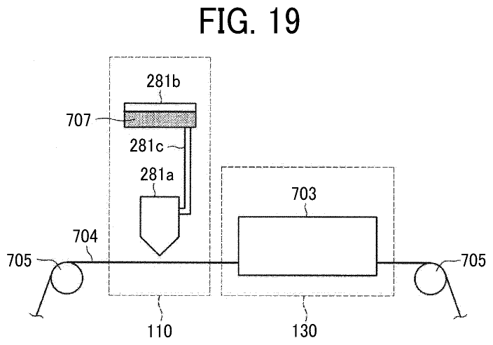

FIG. 18 is a schematic diagram illustrating another head unit 550. As illustrated in FIG. 18, in the head module 100, the arrangement of the liquid discharge head 1 can be appropriately changed. For example, as illustrated in FIG. 18, the liquid discharge heads 1 may be arranged in a staggered manner.

### Electrode Manufacturing Apparatus

The liquid discharge apparatus may also include an apparatus for manufacturing an electrode and an electrochemical element that is also referred to as an electrode manufacturing apparatus. The electrode manufacturing apparatus is described below.

FIG. 19 is a schematic view of an electrode manufacturing apparatus. The electrode manufacturing apparatus is an apparatus for manufacturing an electrode including a layer containing an electrode material by discharging a liquid composition using a head module including a liquid discharge head.

### Device for Forming Layer Containing Electrode Material and Process of Forming Layer Containing Electrode Material

A discharge device (e.g., a discharge process device 110) in the electrode manufacturing apparatus illustrated in FIG. 19 is the head module. The liquid discharge head of the head module discharges a liquid composition. By so doing, the liquid composition is applied onto an object (i.e., a medium), and a liquid composition layer is formed on the object. The object, which may also be referred to as a discharge target in the following description, is not limited to any particular object and may be appropriately selected depending on the intended purpose, as long as the object is an object on which a layer containing an electrode material is to be formed. Examples of the object include an electrode substrate, i.e., a current collector, an active material layer, and a layer containing a solid electrode material. The object may be an electrode composite layer containing an active material on an electrode substrate, i.e., a current collector.

The discharge device and a discharge process may be a device and a process of forming a layer containing an electrode material by directly discharging a liquid composition as long as the layer containing an electrode material can be formed on a discharge target. The discharge device and the discharge process may be a device and a process of forming a layer containing an electrode material by indirectly discharging a liquid composition.

### Other Devices and Other Processes

Other configurations included in the electrode manufacturing apparatus for manufacturing an electrode composite layer are not limited to any particular configuration and may be appropriately selected depending on the intended purpose, as long as the effects of the present embodiment are not impaired. Other processes included in the method for manufacturing an electrode composite layer are not limited to any particular process and may be appropriately selected depending on the intended purpose, as long as the effects of the present embodiment are not impaired. For example, a heating device (e.g., a heating process device 130) and a heating process are examples of the configuration and the process included in the electrode manufacturing apparatus and the manufacturing method of the electrode composite layer.

### Heating Device and Heating Process

The heating device included the electrode manufacturing apparatus for manufacturing an electrode composite layer is a device that heats the liquid composition discharged by the discharge device. The heating process included in the manufacturing method for manufacturing an electrode composite layer is a process of heating the liquid composition discharged in the discharge process. The liquid composition is heated to dry the liquid composition layer.

### Structure to Form Layer Containing Electrode Material by Direct Discharge of Liquid Composition

As an example of the electrode manufacturing apparatus, an electrode manufacturing apparatus that forms an electrode composite layer containing an active material on an electrode substrate, i.e., a current collector, is described below.

As illustrated in FIG. 19, the electrode manufacturing apparatus includes the discharge process device 110 and the heating process device 130. The discharge process device 110 performs a discharge process of applying a liquid composition onto a print base material 704 having a discharge target to form a liquid composition layer. The heating process device 130 performs a heating process of heating the liquid composition layer to obtain an electrode composite layer.

The electrode manufacturing apparatus includes a conveyor 705 that conveys the print base material 704 (i.e., a medium). The conveyor 705 conveys the print base material 704 to the discharge process device 110 and the heating process device 130 in this order at a preset speed. A method of producing the print base material 704 having the discharge target such as an active material layer is not limited to any particular method, and a known method can be appropriately selected.

The discharge process device 110 includes a liquid discharge head 281a (e.g., the liquid discharge head 1 described above) that performs an application process of applying the liquid composition onto the print base material 704, a storage container 281b that stores a liquid composition 707, and a supply tube 281c that supplies the liquid composition 707 stored in the storage container 281b to the liquid discharge head 281a. The discharge process device 110 discharges the liquid composition 707 from the liquid discharge head 281a so that the liquid composition 707 is applied onto the print base material 704 to form a liquid composition layer in a thin film shape.

The storage container 281b may be integrated with the electrode manufacturing apparatus that forms the electrode composite layer or may be detachable from the electrode manufacturing apparatus. The storage container 281b may be a container additionally attachable to a container integrated with the electrode manufacturing apparatus for manufacturing the electrode composite layer or to a container detachable from the electrode manufacturing apparatus for manufacturing the electrode composite layer.

The storage container 281b that stably stores the liquid composition 707 and the supply tube 281c that stably supplies the liquid composition 707 can be used.

The heating process device 130 performs a solvent removal process of heating and removing the solvent remaining in the liquid composition layer. Specifically, the solvent that remains in the liquid composition layer is heated and dried by a heater 703 of the heating process device 130. Accordingly, the solvent is removed from the liquid composition layer. Thus, the electrode composite layer is formed. The heating process device 130 may perform the solvent removal process under reduced pressure.

The heater 703 is not limited to any particular heater and may be appropriately selected depending on the intended purpose. For example, the heater 703 may be a substrate heater, an infrared (IR) heater, or a hot air heater. The heater 703 may be a combination of at least two of the substrate heater, the IR heater, and the hot air heater. A heating temperature and heating time can be appropriately selected according to the boiling point of the solvent contained in the liquid composition 707 or the thickness of a formed film.

The electrode manufacturing apparatus is used to discharge the liquid composition to a desired position on the discharge target. The electrode composite layer can be suitably used, for example, as a part of the configuration of an electrochemical element. The configuration of the electrochemical element other than the electrode composite layer is not limited to any particular configuration, and a known configuration can be appropriately selected. Examples of the configuration other than the electrode composite layer include a positive electrode, a negative electrode, and a separator.

Aspects of the present disclosure are, for example, as follows.

### Aspect 1

A liquid discharge head is provided with an overlapping region. Two or more liquid discharge heads are arranged in a staggered manner in the longitudinal direction. The liquid discharge head has multiple nozzle arrays in which nozzles are arrayed to discharge a liquid onto a medium. In the overlapping region, the nozzle density of the nozzle array on the upstream side in a conveyance direction of the medium is lower than the nozzle density of the nozzle array on the most downstream side in the conveyance direction of the medium.

In other words, a head unit includes a first head and a second head. The first head has a first nozzle array and a second nozzle array. The first nozzle array has first multiple nozzles arrayed in a first direction. The second nozzle array is disposed downstream of the first nozzle array in a second direction intersecting the first direction and has second multiple nozzles arrayed in the first direction. The second head is disposed downstream of the first head in the second direction and arranged adjacent to the first head in a staggered manner. The second head has a third nozzle array and a fourth nozzle array. The third nozzle array has third multiple nozzles arrayed in the first direction. The fourth nozzle array is disposed downstream of the third nozzle array in the second direction and has fourth multiple nozzles arrayed in the first direction. Each of the first head and the second head has an overlapping region in which the first head and the second head overlap with each other in the first direction. The first nozzle array of the first head has a first nozzle density in the first direction in the overlapping region, and the fourth nozzle array of the second head has a second nozzle density larger than the first nozzle density in the first direction in the overlapping region.

### Aspect 2

In the liquid discharge head according to Aspect 1, in the overlapping region, the nozzles of the nozzle array on the upstream side in the conveyance direction of the medium discharge the liquid from the nozzles of both the liquid discharge heads overlapped with each other in the overlapping region. The dot density of the printing result is made equal to the dot density outside the overlapping region.

In other words, in the head unit according to Aspect 1, the second nozzle array of the first head has a third nozzle density larger than the first nozzle density of the first head in the first direction in the overlapping region. The third nozzle array of the second head has a fourth nozzle density smaller than the second nozzle density of the second head in the first direction in the overlapping region. Each of the first head and the second head has a non-overlapping region in which the first head and the second head do not overlap with each other in the first direction. Each of the first nozzle array and the second nozzle array in the first head, and the third nozzle array and the fourth nozzle array in the second head, in the non-overlapping region, has a same nozzle density larger than the first nozzle density of the first nozzle array of the first head in the first direction in the overlapping region. A sum of: the first nozzle density of the first nozzle array of the first head in the overlapping region; and the fourth nozzle density of the third nozzle array of the second head in the overlapping region, is equal to the same nozzle density of the first nozzle array, the second nozzle array, the third nozzle array, and the fourth nozzle array in the non-overlapping region.

In addition, each of: the third nozzle density of the second nozzle array of the first head in the overlapping region; and the second nozzle density of the fourth nozzle array of the second head in the overlapping region, is equal to the same nozzle density in the non-overlapping region.

### Aspect 3

In the liquid discharge head according to Aspect 2, in the overlapping region, the nozzle density of the nozzle array on the upstream side in the conveyance direction of the medium is ½ of the nozzle density of the nozzle array on the downstream side in the conveyance direction of the medium.

In other words, in the head unit according to Aspect 2, the first nozzle density is equal to a half of the second nozzle density in the first direction in the overlapping region.

### Aspect 4

In the liquid discharge head according to Aspect 2, among the liquid discharge heads arranged in a staggered manner, the nozzle density of the nozzle array on the upstream side in the conveyance direction of the medium in the overlapping region of the liquid discharge head arranged on the upstream side in the conveyance direction of the medium is set to be lower than the nozzle density of the nozzle array on the upstream side in the conveyance direction of the medium in the overlapping region of the liquid discharge head arranged on the downstream side in the conveyance direction of the medium.

In other words, in the head unit according to Aspect 2, the first nozzle density of the first nozzle array of the first head in the overlapping region is smaller than the fourth nozzle density of the third nozzle array of the second head in the first direction in the overlapping region.

### Aspect 5

In the liquid discharge head according to Aspect 2, the liquid discharge head has three or more nozzle arrays. In the overlapping region, the nozzle density of N rows (where N is an integer equal to or greater than 1 and less than the total number of nozzle arrays) of the nozzle arrays on the upstream side in the conveyance direction of the medium is 1/(2N) of the nozzle density of the nozzle arrays on the downstream side in the conveyance direction of the medium.

In other words, in the head unit according to Aspect 2, the first head has three or more nozzle arrays including the second nozzle array and N nozzle arrays. The N nozzle arrays are disposed upstream of the second nozzle array in the second direction and include the first nozzle array. Each of the N nozzle arrays has the first nozzle density equal to 1/(2N) of the second nozzle density of the fourth nozzle array of the second head in the first direction in the overlapping region.

### Aspect 6

In the liquid discharge head according to Aspect 5, in the overlapping region, the nozzle density of at least two rows of the nozzle arrays on the upstream side in the conveyance direction of the medium is lower than the nozzle density of the nozzle arrays on the downstream side in the conveyance direction of the medium. The nozzle arrays in which the nozzle density on the upstream side in the conveyance direction of the medium is reduced have the nozzle density that decreases toward the upstream side in the conveyance direction of the medium.

In other words, in the head unit according to Aspect 4, the first head has three or more nozzle arrays including the second nozzle array and two or more nozzle arrays. The two or more nozzle arrays are disposed upstream of the second nozzle array in the second direction and include the first nozzle array. The two or more nozzle arrays each have the first nozzle density decreasing upstream in the second direction.

### Aspect 7

In the liquid discharge head according to Aspect 2, the nozzle plate on which the nozzle arrays are formed has a trapezoidal shape with a longer base of the trapezoidal shape of the nozzle plate disposed upstream in the conveyance direction of the medium.

In other words, in the head unit according to Aspect 2, each of the first head and the second head includes a nozzle plate having a trapezoidal shape with a longer base of the trapezoidal shape facing upstream in the second direction. Corresponding nozzles including: the first multiple nozzles and the second multiple nozzles; or the third multiple nozzles and the fourth multiple nozzles, are arrayed on the nozzle plate in the first direction.

### Aspect 8

A liquid discharge unit includes the liquid discharge head according to any one of Aspects 1 to 7.

### Aspect 9

The liquid discharge unit according to Aspect 8, further includes at least one of a head tank to store a liquid to be supplied to the liquid discharge head, a carriage to mount the liquid discharge head, a supply mechanism to supply the liquid to the liquid discharge head, a maintenance mechanism to maintain and recover the liquid discharge head, or a main-scanning moving mechanism to move the liquid discharge head in a main scanning direction. The at least one thereof is integrated with the liquid discharge head as a single unit.

In other words, the head unit according to Aspect 1, further includes at least one of: a head tank to store a liquid to be supplied to the head unit; a carriage mounting the head unit; a supply mechanism to supply the liquid to the head unit; a maintenance mechanism to maintain and recover the head unit; or a main-scanning moving mechanism to move the head unit in a main scanning direction, to form a single unit integrated with the head unit.

### Aspect 10

A liquid discharge apparatus includes the liquid discharge head according to any one of Aspects 1 to 7.

### Aspect 11

A liquid discharge apparatus includes the liquid discharge unit according to Aspect 8 or 9.

In other word, a liquid discharge apparatus includes: the head unit according to Aspect 1, to discharge a liquid onto a medium from the first head and the second head; and a conveyor to convey the medium relative to the head unit in the second direction.

Alternatively, a liquid discharge apparatus includes: the head unit according to claim 1, to discharge a liquid onto a medium from the first head and the second head; a carriage mounting the head unit to move the head unit relative to the medium in a third direction opposite to the second direction; and a conveyor to convey the medium relative to the head unit in the first direction.

As described above, according to one aspect of the present disclosure, when two or more liquid discharge heads are arranged in a staggered manner in the longitudinal direction with an overlapping region therebetween, a liquid discharge head, a liquid discharge unit, and a liquid discharge apparatus can reduce a deviation in the landing position of liquid to form a desired image without complicating a control mechanism.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A head unit comprising:
a first head having:
a first nozzle array having first multiple nozzles arrayed in a first direction; and
a second nozzle array:
disposed downstream of the first nozzle array in a second direction intersecting the first direction; and
having second multiple nozzles arrayed in the first direction; and
a second head:
disposed downstream of the first head in the second direction; and
arranged adjacent to the first head in a staggered manner,
the second head having:
a third nozzle array having third multiple nozzles arrayed in the first direction; and
a fourth nozzle array:
disposed downstream of the third nozzle array in the second direction; and
having fourth multiple nozzles arrayed in the first direction,
wherein each of the first head and the second head has an overlapping region in which the first head and the second head overlap with each other in the first direction,
the first nozzle array of the first head has a first nozzle density in the first direction in the overlapping region, and
the fourth nozzle array of the second head has a second nozzle density larger than the first nozzle density in the first direction in the overlapping region.

2. The head unit according to claim 1,
wherein the second nozzle array of the first head has a third nozzle density larger than the first nozzle density of the first head in the first direction in the overlapping region,
the third nozzle array of the second head has a fourth nozzle density smaller than the second nozzle density of the second head in the first direction in the overlapping region,
each of the first head and the second head has a non-overlapping region in which the first head and the second head do not overlap with each other in the first direction,
each of the first nozzle array and the second nozzle array in the first head, and the third nozzle array and the fourth nozzle array in the second head, in the non-overlapping region,
has a same nozzle density larger than the first nozzle density of the first nozzle array of the first head in the first direction in the overlapping region, and
a sum of:
the first nozzle density of the first nozzle array of the first head in the overlapping region; and
the fourth nozzle density of the third nozzle array of the second head in the overlapping region,
is equal to the same nozzle density of the first nozzle array, the second nozzle array, the third nozzle array, and the fourth nozzle array in the non-overlapping region.

3. The head unit according to claim 2,
wherein each of:
the third nozzle density of the second nozzle array of the first head in the overlapping region; and
the second nozzle density of the fourth nozzle array of the second head in the overlapping region,
is equal to the same nozzle density in the non-overlapping region.

4. The head unit according to claim 2,
wherein the first nozzle density is equal to a half of the second nozzle density in the first direction in the overlapping region.

5. The head unit according to claim 2,
wherein the first nozzle density of the first nozzle array of the first head in the overlapping region is smaller than the fourth nozzle density of the third nozzle array of the second head in the first direction in the overlapping region.

6. The head unit according to claim 2,
wherein the first head has three or more nozzle arrays including:
the second nozzle array; and
N nozzle arrays:
disposed upstream of the second nozzle array in the second direction; and
including the first nozzle array, and
each of the N nozzle arrays has the first nozzle density equal to 1/(2N) of the second nozzle density of the fourth nozzle array of the second head in the first direction in the overlapping region.

7. The head unit according to claim 2,
wherein the first head has three or more nozzle arrays including:
the second nozzle array; and
two or more nozzle arrays:
disposed upstream of the second nozzle array in the second direction; and
including the first nozzle array, and
the two or more nozzle arrays each have the first nozzle density decreasing upstream in the second direction.

8. The head unit according to claim 2,
wherein each of the first head and the second head includes a nozzle plate having a trapezoidal shape with a longer base of the trapezoidal shape facing upstream in the second direction, and
corresponding nozzles including:
the first multiple nozzles and the second multiple nozzles; or
the third multiple nozzles and the fourth multiple nozzles,
are arrayed on the nozzle plate in the first direction.

9. The head unit according to claim 1, further comprising at least one of:
a head tank to store a liquid to be supplied to the head unit;
a carriage mounting the head unit;
a supply mechanism to supply the liquid to the head unit;
a maintenance mechanism to maintain and recover the head unit; or
a main-scanning moving mechanism to move the head unit in a main scanning direction,
to form a single unit integrated with the head unit.

10. A liquid discharge apparatus comprising:
the head unit according to claim 1, to discharge a liquid onto a medium from the first head and the second head; and
a conveyor to convey the medium relative to the head unit in the second direction.

11. A liquid discharge apparatus comprising:
the head unit according to claim 1, to discharge a liquid onto a medium from the first head and the second head;
a carriage mounting the head unit to move the head unit relative to the medium in a third direction opposite to the second direction; and
a conveyor to convey the medium relative to the head unit in the first direction.
